(19) United States
(12) Patent Application Publication
(10) Pub. No.: US 2007/0022862 A1
(43) Pub. Date: Feb. 1, 2007

(54) HORIZONTAL PAPER CUTTER FOR ROUNDING CORNERS

(76) Inventors: Charles A. ROSS SR., Overland Park, KS (US); Thomas L. Jennings, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/456,775

(22) Filed: Jul. 11, 2006

Related U.S. Application Data
(60) Provisional application No. 60/698,574, filed on Jul. 12, 2005.

(51) Int. Cl. B23D 7/00; B27B 19/00

(52) U.S. Cl. 83/746

(57) ABSTRACT

An apparatus (10) for cutting a corner of a stack (66) of sheet material, such as paper or plastic cards, to have a non-square shape. Broadly, the apparatus (10) includes a tray (12) for receiving the stack (66) such that the corner of the stack (66) projects through a gap (22) in the tray (12) into a cutting path, a blade assembly (14) which is slidable along the cutting path to cut the corner of the stack (66), a drive assembly (16) for driving the blade assembly (14) along the cutting path, a clamping assembly (74) for exerting a clamping force on the stack (66), and one or more spacer blocks (70,72) that fit closely within the tray (12) and do not project into the cutting path, including a spacer block (70) which is interposed between the clamping assembly (74) and the stack (66).

### RELATED APPLICATIONS

The present non-provisional patent application claims priority benefit of an earlier-filed provisional patent application of the same title, Ser. No. 60/698,574, filed Jul. 12, 2005. The identified earlier-filed application is hereby incorporated by reference into the present application.

### FIELD OF THE INVENTION

The present invention relates to apparatuses for cutting stacks of sheet material. More specifically, the present invention concerns an apparatus for cutting a corner of a stack of sheet material, e.g., paper or plastic cards, to have a non-square, e.g., rounded, shape, wherein the apparatus receives and retains the individual sheet material members of the stack in a substantially vertical orientation such that the force of gravity assists in properly positioning the individual members for cutting.

### BACKGROUND OF THE INVENTION

Apparatuses for cutting stacks of sheet material, such as paper cards, are known that are vertical in orientation, such that the stacks, and the individual sheet material members of the stacks, are oriented horizontally within the apparatuses during the cutting process. Unfortunately, this can result in disorientation of the individual sheet material members, as well as the stack as a whole, resulting in a non-uniform cut.

Apparatuses for cutting such stacks are also known that cut only in one direction along a cutting path. Unfortunately, this unidirectional cutting limitation can result in poor or incomplete cuts.

Due to these and other problems and disadvantages in the prior art, a need exists for an improved apparatus for cutting sheet material.

### SUMMARY OF THE INVENTION

The present invention is an apparatus for cutting a corner of a stack of sheet material, e.g., paper or plastic cards, to have a non-square, e.g., rounded, shape, wherein the apparatus receives and retains the individual sheet material members of the stack in a substantially vertical orientation such that the force of gravity assists in properly positioning the individual members for cutting.

Broadly, in one embodiment the apparatus comprises a tray, a blade assembly, and a drive assembly. The tray assembly receives the stack such that the corner of the stack is located in a cutting path. The tray is oriented substantially horizontally, and includes a bin having a gap through which the corner of the stack projects into the cutting path. The bin includes a first support panel and a second support panel angularly oriented relative to one another and separated by the gap. The cutting path is substantially linear, and the first direction corresponds to a forward direction and the second direction corresponds to a rearward direction along the cutting path.

The blade assembly moves along the cutting path to cut the corner of the stack. The blade assembly includes a first cutting edge having the non-square shape and oriented toward a first, or forward, direction along the cutting path and a second cutting edge having the non-square shape and oriented toward a second, or rearward, direction along the cutting path. A top surface of the blade assembly has a groove which corresponds to the non-square shape. The non-square shape may be a substantially rounded shape, in which case the first cutting edge and the second cutting edge each include a first end and a second end which are flared to better accomplish a smoother transition between the substantially straight sides of the sheet material.

The drive assembly is connected to the blade assembly for facilitating driving the blade assembly along the cutting path.

The apparatus may further include one or more spacer blocks for occupying space within the tray which is not occupied by the stack. Each such spacer block fits closely within the bin and does not project into or otherwise obstruct the cutting path. There are at least a first spacer block and a second spacer block for positioning in front of and behind the stack, respectively.

The apparatus may further include a clamping assembly for exerting a clamping force on the stack within the bin. The clamping assembly includes a threaded rod having a first rod end and a second rod end, and a handle connected to the first rod end for turning the threaded rod. The spacer block located in front of the stack is interposed between the clamping assembly and the stack. This spacer block includes an engagement surface against which the clamping assembly exerts the clamping force, wherein the engagement surface is angled relative to a direction of the clamping force so as to force the spacer block both against the bin and against the stack.

These and other important features of the present invention are more fully described in the section titled DETAILED DESCRIPTION OF THE INVENTION, below.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view illustrating an apparatus for rounding the corners of sheet material according to a preferred embodiment of the invention.

FIG. 2 is an exploded view of the apparatus of FIG. 1.

FIG. 3 is a top plan view of the apparatus of FIG. 1.

FIG. 4 is a bottom plan view of the apparatus of FIG. 1.

FIG. 5 is a cross-sectional view taken along lines 5-5 of FIG. 3.

FIG. 6 is a cross-sectional view taken along lines 6-6 of FIG. 3.

FIG. 7 is a top plan view of the cutter blade assembly of the apparatus.

FIG. 8 is a cross-sectional view taken along lines 8-8 of FIG. 7.

FIG. 9 is a cross-sectional view taken along lines 9-9 of FIG. 7.

FIG. 10 is a cross-sectional view taken along lines 10-10 of FIG. 7.

FIG. 11 is a cut-away perspective view illustrating the apparatus in which a stack of sheet material is prepared for cutting.

FIG. 12 is a top plan view of the apparatus as shown in FIG. 11.

FIG. 13 is a cross-sectional view taken along lines 13-13 of FIG. 12.

FIG. 14 is a cross-sectional view taken along lines 14-14 of FIG. 12.

FIG. 15 is a cross-sectional view taken along lines 15-15 of FIG. 12.

FIG. 16 is a cross-sectional view taken along lines 16-16 of FIG. 12.

FIG. 17 is a partial cross-sectional view in side elevation of the apparatus as shown in FIG. 11.

FIG. 18 is a side elevational view taken from the side of the cutter blade assembly shown in FIG. 7.

FIG. 19 is a perspective view illustrating the apparatus for rounding the corners of sheet material according to an alternative preferred embodiment of the invention.

FIG. 20 is an exploded view of the apparatus of FIG. 19.

### DETAILED DESCRIPTION OF THE INVENTION

With reference to the figures, a cutting apparatus 10 is herein described, shown, and otherwise disclosed in accordance with a preferred embodiment of the present invention. Broadly, the apparatus 10 facilitates cutting the orthogonal corner edge of a stack of sheet material, such as paper, plastic, or non-ferrous metal, to produce a shaped corner other than one having a right-angle. In particular, the embodiment described herein is adapted for cutting a rounded corner, but other shapes can also be cut depending on the chosen configuration of the cutting blade.

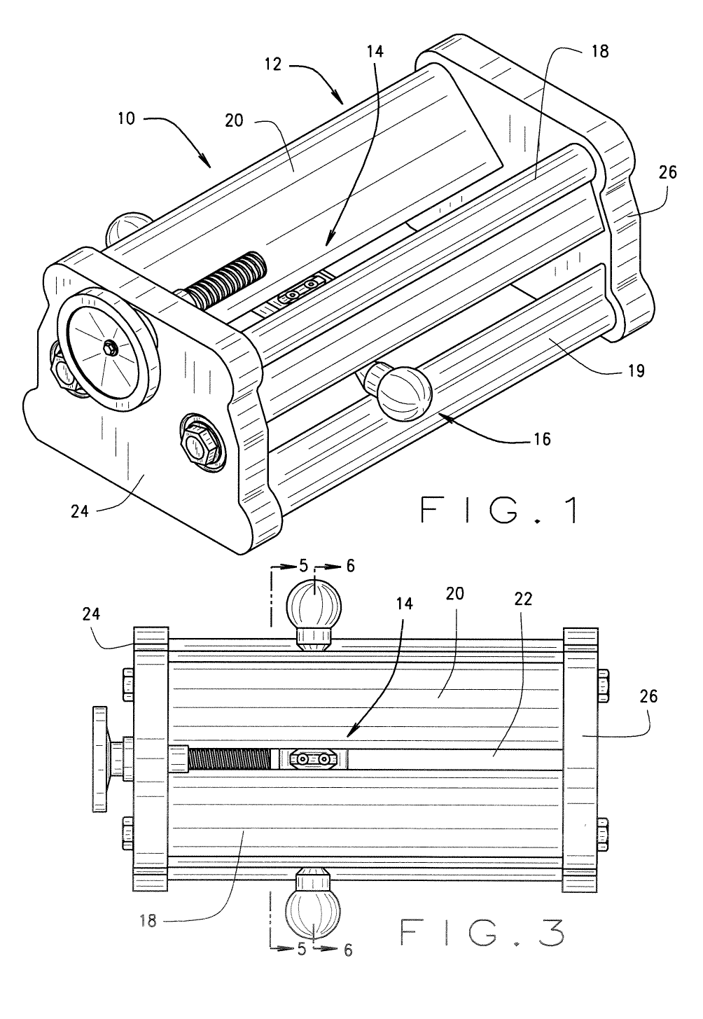

Broadly, the apparatus 10 comprises a housing defining a horizontally disposed tray for receiving the stack 66 in a horizontal, side-by-side position such that a corner edge of each sheet material member of the stack 66 is placed in the cutting path of a rounded blade. The blade is slidably mounted in the housing such that a cutting swath is effected by moving the blade against and along the corner edge of the stack 66. The blade has cutting edges at a leading end and a trailing end to permit bidirectional back-and-forth cutting to ensure a complete and even, rounded cut of the corner of the stack 66. The horizontal disposition of the apparatus, coupled with the angled sides of the housing tray, enable the sheet material members of the stack 66 to be settled into place and quickly aligned. After one corner of the stack 66 is cut, the entire stack 66 can be lifted and simply rotated approximately 90 degrees to present the next adjacent corner for cutting. Referring to FIG. 1, an embodiment of the apparatus 10 broadly comprises a housing having a tray section 12, a cutter blade assembly 14, and a blade drive assembly 16.

The tray section 12 is adapted to receive and retain the stack 66 in a substantially vertical orientation such that the force of gravity assists in properly positioning the sheet material members of the stack 66 for cutting. The tray section 12 comprises upper, opposing support panel members 18,20 which are positioned relative to each other such that their upper surfaces form a bin within the tray section 12. In one embodiment, each support panel member 18,20 is disposed at an approximately 45 degree angle from a center axis, preferably vertically oriented, such that their combined angles create a V-shaped trough with an approximately 90 degree angle and oriented substantially horizontally. In other embodiments, different angles are used to receive differently shaped sheet material. The top edges of the support panel members 18,20 may be extendable or adapted to receive extension members in order to accommodate and properly support larger sheet material during the cutting process. The bottom edges of the support panel members 18,20 are spaced apart to define a gap 22 as shown in FIG. 3. End plate members 24,26 are disposed at the ends of the tray section 12. The support panel members 18,20 are connected to the end plate members 24,26 by bolting, welding, or the like. Reinforcing panels 19,21 provide structural strength and stability to the tray section 12.

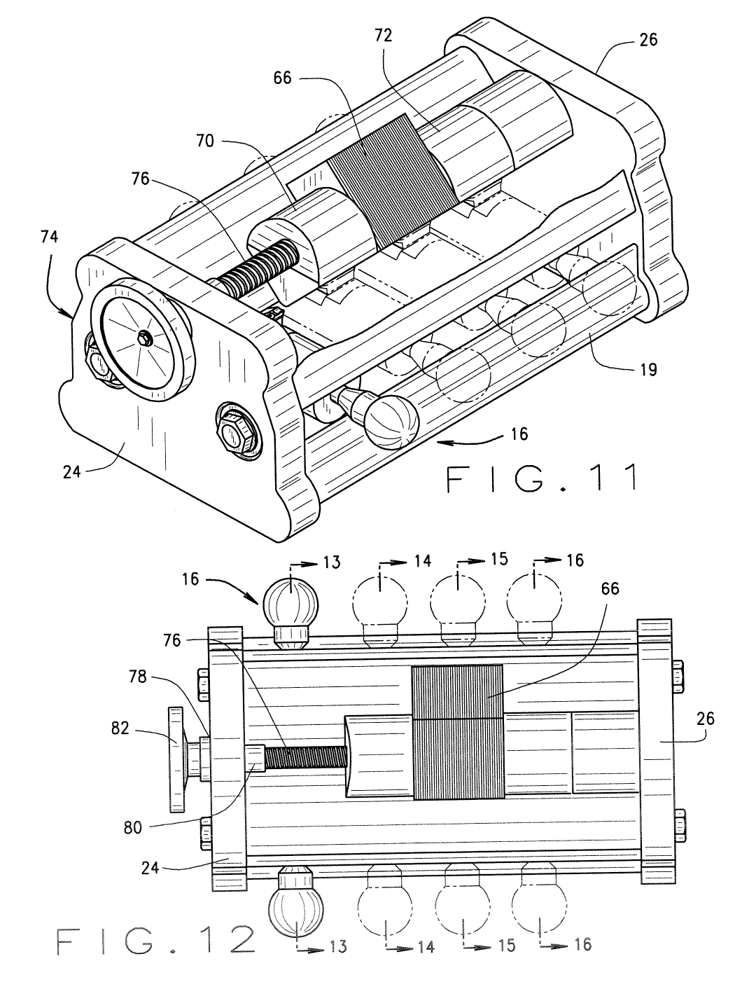

Referring also to FIGS. 7-10 and 18, the cutter blade assembly 14 comprises a cutter body 28, a first cutting edge 30, and a second cutting edge 32. In one embodiment, the first and second cutting edges 30,32 are provided at opposite ends of a double-sided cutting blade. In another embodiment, an extending tongue member 36 projects longitudinally from the cutter body 28 and terminates in the first cutting edge 30, and a second extending tongue member 38 projects longitudinally from the cutter body 28 and terminates in the second cutting edge 32. A top surface of the cutter body 28 defines a groove 34 along its entire length and along the extending tongue members 36,38. The groove 34 is rounded and has a constant dimension, which approximates the radius of curvature of the cutting edges 30,32, throughout its entire length, as shown in FIGS. 8-10. The angle of the tangent lines at the edges of the groove 34 is approximately 90 degrees, and in other embodiments is a little greater than 90 degrees (e.g., 94 degrees in one embodiment) to assure a smooth transition from the rounded corner to the straight edge of the sheet material. Thus, in one embodiment the radius of the groove 34 increases toward the ends. In one embodiment, the flare occurs over the last 1/16 inch of each end. Holes 40,42 are disposed through the cutter body 28 and are adapted to receive fastening members for securing the cutter blade assembly 14 to a surface. The holes 40,42 are countersunk below the bottom surface of the groove 34, as shown in FIG. 10, so that the heads of the fastening members received within the holes 40,42 do not obstruct the passage within and along the groove 34. The cutter body 28 may be provided with an additional surface feature for visually associating the particular cutter body with a corresponding particular spacer block or set of spacer blocks, as described below. In one embodiment, the additional surface feature is an additional hole or indentation painted with a particular color associated with the corresponding particular spacer block or set of spacer blocks.

Each of the extending tongue members 36,38 have bottom edges which angle downwardly from the blade edge, as shown in FIG. 18, urging cut scrap to fall away from the blade. The grooved edge of the first blade as it engages the stack 66 effects a round cut, thereby softening the sharp corner of the stack 66. As described above, outer edges 44,46 of the blade are partially flared out to avoid an uneven cut on the corner of a sheet material member of the stack 66 if it is not exactly lined up for the cut. As the stack 66 is cut, the groove 34 of the cutter body 28 is caused to slide along the newly created rounded corner, permitting the entire cutter assembly 14 to pass by the stack 66. Once passed, the cutter assembly 14 is brought into position to effect a reverse cut, by engaging the second blade against the opposite side of the stack 66. The second cutting pass supplements the cut on the corner of the stack 66 made by the first cutting pass.

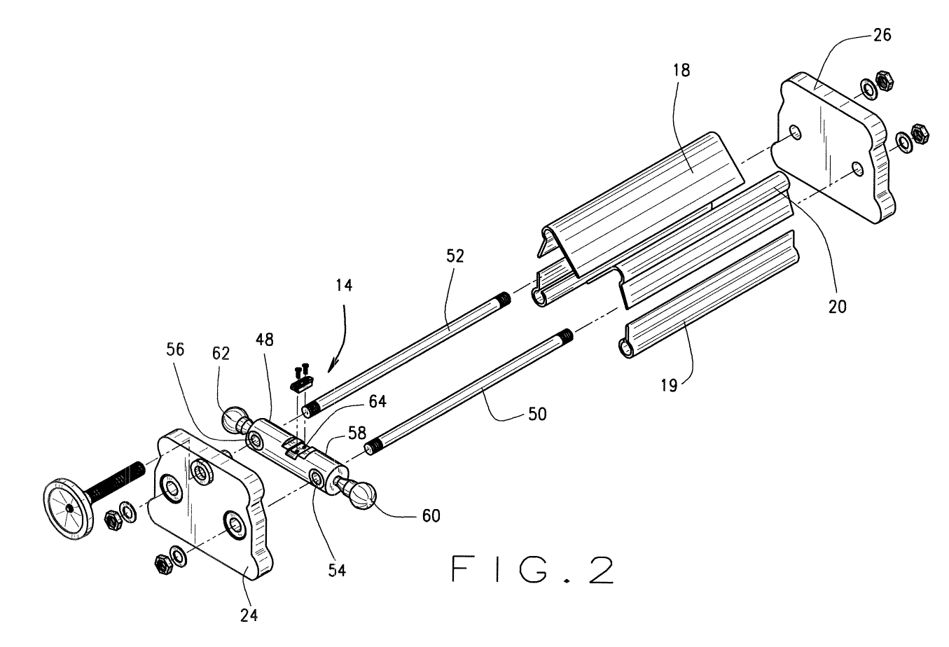

In this embodiment of the invention, the cutter blade assembly 14 is mounted on the blade drive assembly 16. The blade drive assembly 16 is comprised of a carrier member 48 and rail members 50,52, as shown in FIG. 2. The rail members 50,52 span between and are connected to the end plate members 24,26. The carrier member 48 is mounted on the rail members 50,52 such that it is moveable along the rail members 50,52, thereby being able to move the cutter blade assembly 14 back and forth along the tray section 12. The carrier member 48 has channels 54,56 which slidably receive the rail members 50,52. As understood by those having ordinary skill in the art, appropriate bearing mechanisms can be provided within the channels 54,56 for reducing friction as the carrier member 48 slides along the rail members 50,52. It should also be understood that other sliding mechanism arrangements for the blade drive assembly may be employed using greater or fewer rail members or other track assemblies.

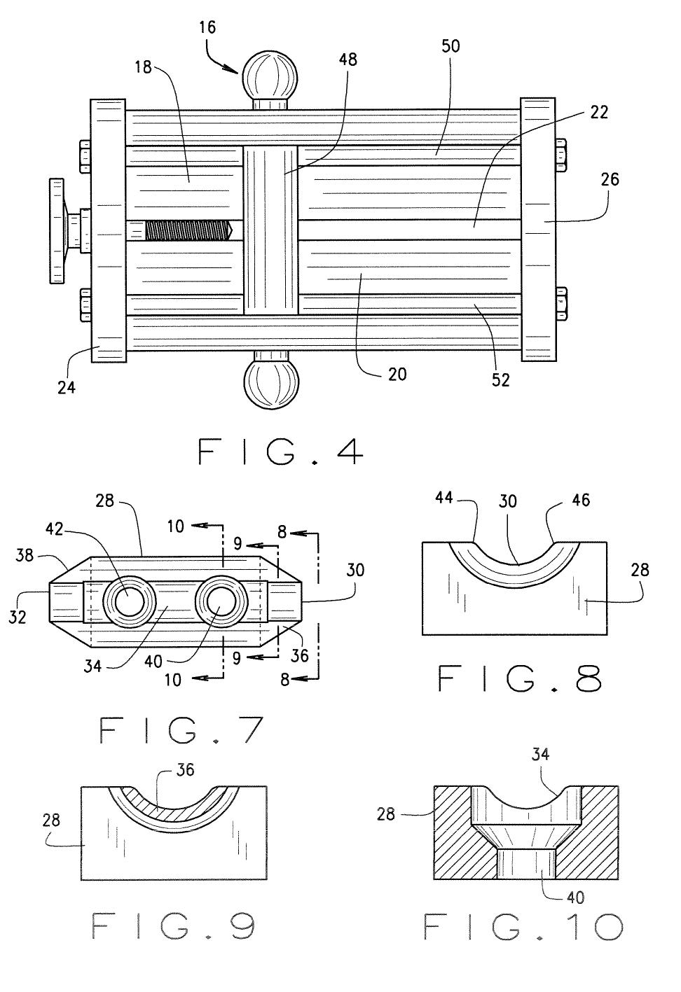

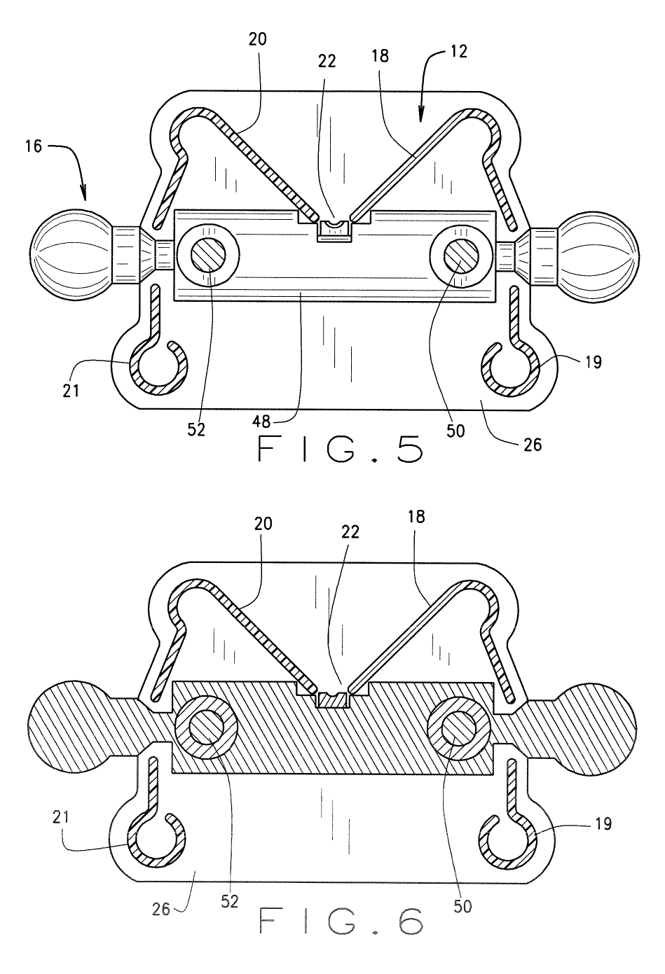

The carrier member 48 has a central body portion 58 having mass to provide sufficient cutting force to the blade assembly 14 as it engages the stack 66. The central body portion 58 may be cylindrical with opposing handles 60,62, which give it a shape similar to that of a rolling pin. As shown in FIG. 2, a groove 64 is perpendicularly disposed on the top surface of the carrier member 48 for receiving the cutter body 28 in an orientation such that the cutting edges 30,32 point and travel in a longitudinal, horizontal direction within the tray section 12. The cutter body 28 is removably secured within the groove 64 which has threaded sockets to receive threaded fasteners passing through the holes 40,42 in the cutter body 28. The rail members 50,52 are positioned underneath the support panel members 18,20 of the tray section 12 such that, when the carrier member 48 is mounted on the rails 50,52, the cutter blade assembly 14 lies in proximity to the gap 22, as shown in FIGS. 5 and 6. The cutter blade assembly 14 is bi-directionally movable longitudinally along the tray section 12 in the gap 22, as shown in FIG. 3, by sliding the carrier member 48 along the rail members 50,52.

The angled orientation of the support panel members 18,20 within the tray section 12 enable the sheet material members of the stack 66 having an orthogonal (or right angle) corner to settle and lay flush against the surface of the support panel members 18,20. The relative angle between the support panel members 18,20 is approximately 90 degrees, which substantially approximates the standard, right angle shape of the corner of the stack 66. The apparatus 10 lies in a substantially horizontal disposition such that the tray section 12 runs parallel to a supporting surface on which the apparatus 10 is placed, as shown in FIG. 1. This construction enables the stack 66 to be simply placed in the tray section 12 where, with the aid of gravity, the edges of the sheet material members of the stack 66 will line up flush and evenly abut against the support panel members 18,20. In an alternate embodiment, the disposition of the apparatus 10 is adjustable to raise one end of the tray section with respect to its other end in order to incline the tray. In this embodiment, the stacking of the sheet material members within the tray section 12 is additionally simplified as gravity will further urge the members into alignment, and cause the members to tilt in a common direction. The gap 22 permits the corner 68 of the stack 66 to lie below the tray section 12 such that the corner 68 is exposed for engagement with the cutter blade assembly 14 and the blade drive assembly 16, as shown in FIG. 15.

The tray section 12 has a length sufficient to accommodate a large stack 66. However, any particular cutting operation may involve a number of sheet material members whose stacked length is substantially less than the length of the tray section 12. Accordingly, spacer blocks 70,72 are provided for occupying the unused space within the tray section 12, as shown in FIG. 11. A clamping assembly 74 securely holds the stack 66 in place within the tray while the cutting operation takes place. The clamping assembly 74 comprises a threaded push rod member 76 extending through the end plate 24 and threadedly received in bushings 78,80, as seen in FIG. 12. The bushings 78,80 reinforce the end plate 24 and the inner bushing 80 is of sufficient length to stabilize the push rod member 76. A handle 82 is provided for rotating the push rod member 76 about its threaded engagement to effect its extension length from the end plate 24. As seen in FIG. 11, the push rod member 76 exerts pressure on the spacer block 70, which in turn effectively clamps the stack 66 in place.

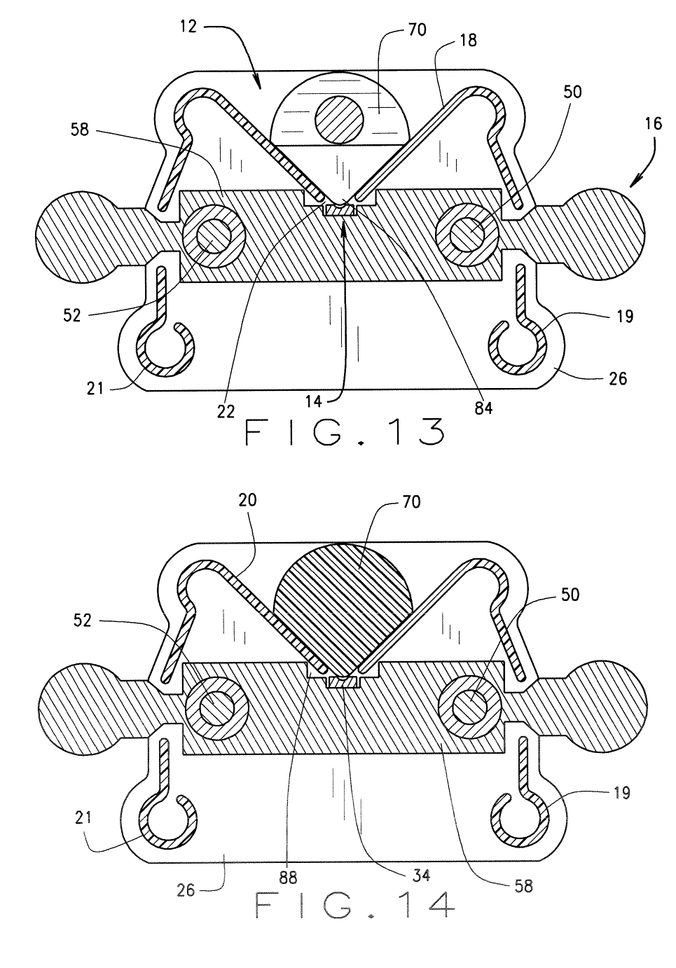

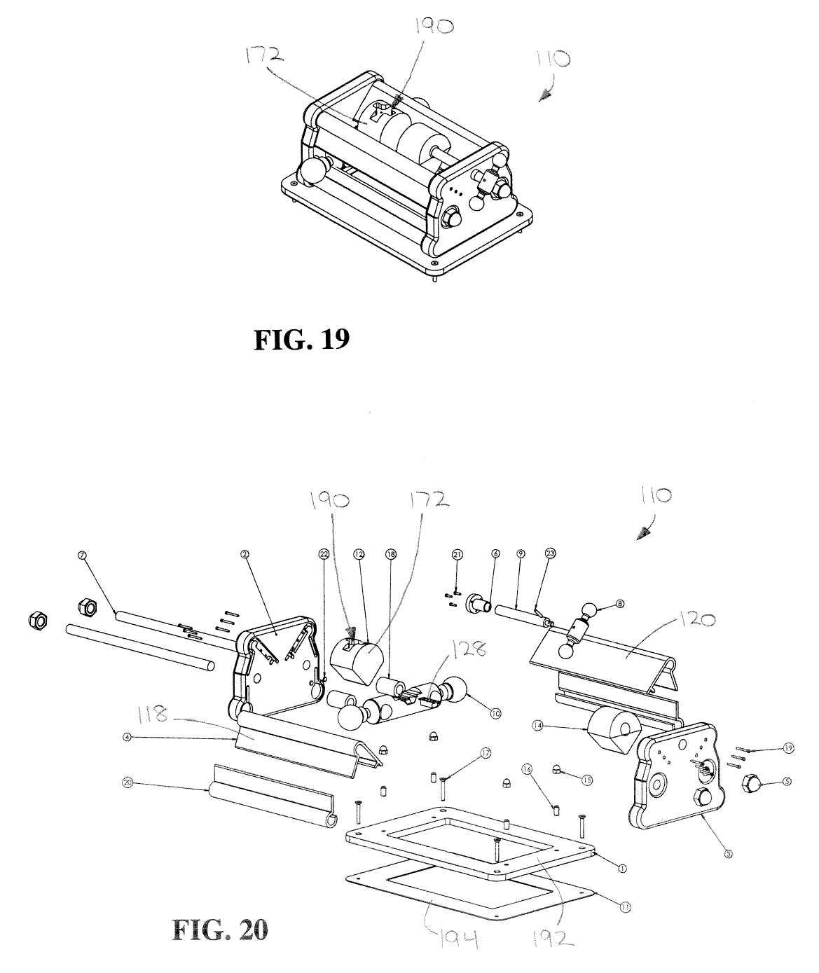

Each spacer block 70,72 is configured to have a bottom portion formed with an approximately 90 degree angle so that it abuts precisely with the support panels 18,20 of the tray section 12. The bottom apex 84 of each block extends through the gap 22, thus placing it just above the path of the cutter blade assembly 14, as shown in FIG. 13. Accordingly, the bottom apex 84 has a curved shape having a degree of curvature approximating that of the groove 34 of the cutter body 28. In another embodiment, the bottom apex 84 is flat and extends across the gap 22. This permits the cutter blade assembly 14 to pass unobstructed along the bottom of the spacer blocks 70,72 as it cuts the exposed corners of the stack 66 braced within the tray section 12. This configuration further permits the spacer blocks 70,72 to provide as much bracing surface area as possible to the stack 66 to prevent inadvertent bending of the corners. As mentioned, particular cutting bodies may be associated with corresponding particular spacer blocks by an appropriate visual indication, e.g., color. In one embodiment, the spacer block 172 may include, in its top surface, a receiver 190 for receiving the corresponding particular cutting body 128, thereby allowing for physically associating the cutting body 128 and corresponding spacer block 172 when not in use, as shown in FIGS. 19 and 20.

During operation, it is desirable to have spacer blocks 70,72 on either side of the stack 66, as shown in FIG. 12, to permit sufficient clearance of the blade drive assembly 16 on both sides of the stack 66. This permits bi-directional cutting of the front and back sides of the stack 66, thus utilizing both first and second cutting edges 30,32 of the blade assembly 14. Specifically, placing a spacer block 72 opposite the starting end of the cut allows the cutting tool to slide all the way underneath the spacer block 72 so that the return cut begins with the blade spaced from the stack 66.

The apparatus 10 is employed for cutting sharp corners to form a rounded edge on the corner of the stack 66. In preparation, the blade drive assembly 16 is brought back against the end plate 24 and the stack 66 of sheet material is placed in the tray section 12, as shown in FIGS. 11 and 12. The angled edges of the support panel members 18,20 ensure that the edges of the sheet material member of the stack 66 abut precisely in the tray, and that a uniform portion of the corner of each member extends into the gap 22, as shown in FIG. 17. If any sheet material members of the stack 66 are initially out of alignment, they can be simply tapped down. Although the tray can accommodate a large stack 66, it is advantageous to ensure that space is left on either side of the stack 66 within the tray so that the entire blade drive assembly 16 can completely pass the stack 66 on both ends of the stack 66. Therefore, a front spacer block 70 is placed in front of the stack 66 and a rear spacer block 72 is placed behind the stack 66. Additional spacer blocks may be used as needed. It is necessary to securely clamp the stack 66 in place, so the threaded rod member 76 is drawn tight against the front edge of the spacer block 70. In one embodiment, the block 70 is provided with a hard plastic or metal wear plug to engage the end of the rod 76 and limit wear to the block 70. In the presently described embodiment, the clamping assembly 74 is positioned in the upper region of the end plate 24 thereby slightly offsetting the push rod member 76 from central engagement with the spacer block 70. To avoid the spacer block 70 tipping off center when engaged by the push rod member 76, the front engaging edge 86 is angled slightly from vertical, as shown in FIG. 17. The engaging edge angle is preferably approximately 10 degrees with respect to the upright axis, which is substantially vertical, of the apparatus 10. Further, the tip 87 of the rod 76 is crowned at an angle of approximately 10 degrees to substantially match the angle of the spacer block 70 and force the spacer block 70 down into the tray. This also tends to force the stack 66 down into the tray. Alternate clamping mechanisms, such as a lever clamp, may also be used to secure the stack 66.

Once the stack 66 is secured in the tray, the blade drive assembly 16 is actuated to draw the cutter blade assembly 14 across the exposed corner of the stack 66. In the present embodiment, the handles 60,62 are provided so that a person may manually actuate the blade drive assembly 16 by pushing and pulling it longitudinally along the tray section 12. Although not shown here, it would be understandable to a person having ordinary skill in the art to provide an automated arrangement for actuating the blade drive assembly 16.

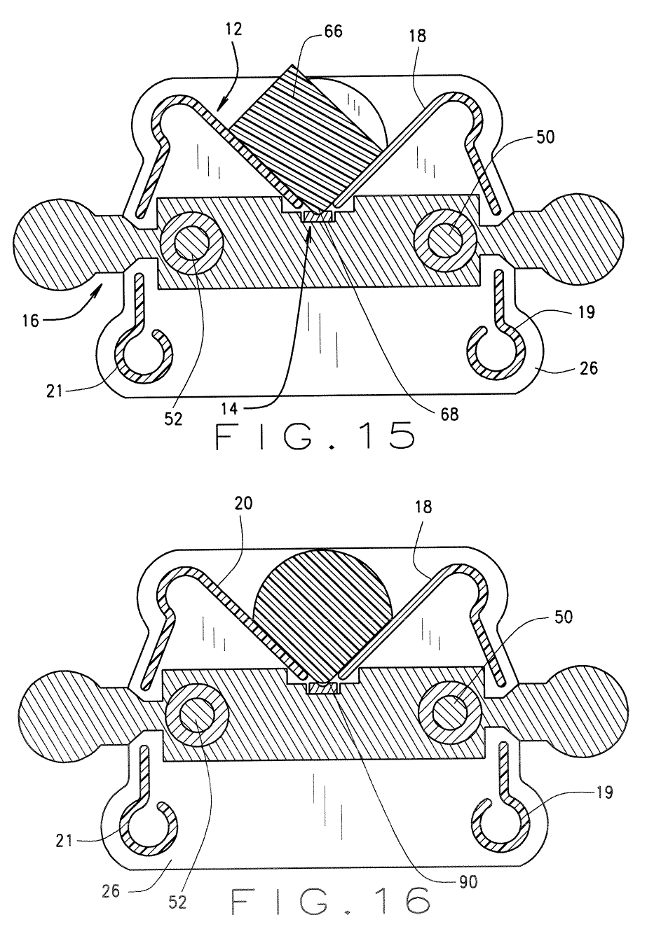

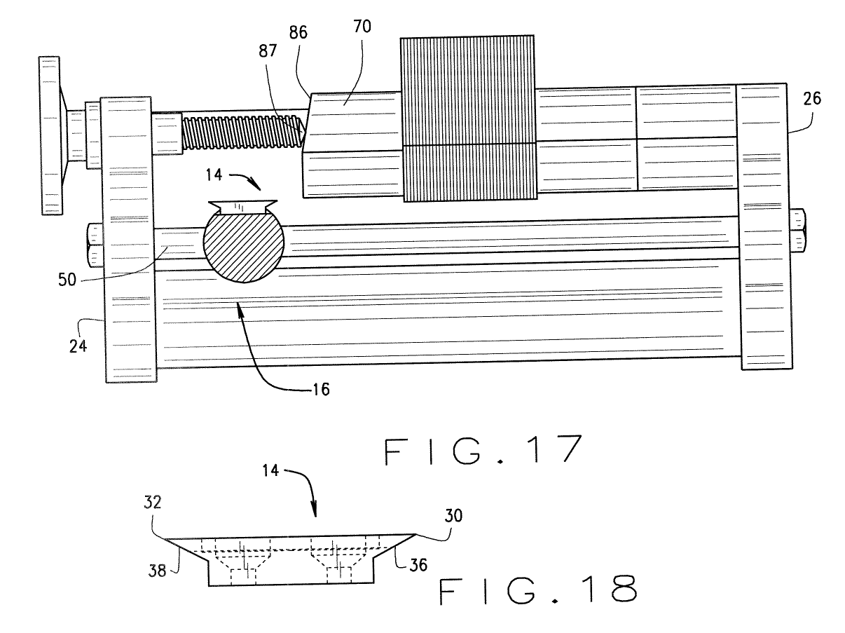

For purposes of explanation of the cutting operation, reference is made to FIGS. 12-16. The central body portion 58 of the blade drive assembly 16 is slidably mounted on the rails 50,52, and as it advances down the tray section 12 along the rails 50,52 it first approaches the front spacer block 70, as shown in FIG. 13. As can be seen in FIG. 14, the central body portion 58 is configured with an inwardly offset portion 88 in its top surface which provides a sufficient dimension to receive the bottom portion of the tray section 12 and the bottom apex 84 of the spacer block 70. Similarly, the apex 84 has a dimension slightly less than that of the groove 34 of the cutter body 28 so that the apex 84 will pass within the groove 34 and the blade assembly 14 will pass over the apex 84. As the blade drive assembly 16 passes the front spacer block 70 it next approaches the stack 66, as shown in FIG. 15. The orthogonal corner of the stack 66 exposed through the gap 22 is cut off by the first edge 30 of the cutter blade to leave a rounded corner. For thorough cutting, the blade drive assembly 16 is pushed entirely past the stack 66, as seen in FIG. 16. The apex 90 of the rear spacer block 72 has a dimension slightly less than that of the groove 34 of the cutter body 28 so that the apex 90 will pass within the groove 34 and the blade assembly 14 will pass over the apex 90.

The force by which the blade drive assembly 16 is pushed against the stack 66 can be significant, so the end plates 24,26 can be reinforced to absorb the shock when the blade drive assembly 16 is pushed against them. In one embodiment, a cushion bumper is provided on the end plates 24,26 to stop the motion of the drive assembly 16. Upon completion of the first passage of the blade drive assembly 16 past the front edge of the stack 66, it becomes in position to be actuated for return passage against the back edge of the stack 66. If an incomplete cut was made on the first forward passage, a second reverse passage cut should be sufficient to produce a complete cut. The second cutting edge 32 and the back side of cutter body 28, and the bi-directional sliding capability of the blade drive assembly 16, permit a reverse cut to be made simply by sliding the blade drive assembly 16 back along the rail members 50,52.

The operation is repeated for each corner of the stack 66. The stack 66 is unclamped by turning the handle 82 to loosen the push rod member 76. Once unclamped, the entire stack 66 is lifted and rotated approximately 90 degrees and placed back in the tray section 12. The stack 66 is again clamped and the cutting process is repeated as described above. The remaining two corners of the stack 66 are processed similarly, each time rotating the stack 66 approximately 90 degrees to present the next adjacent corner for cutting. The horizontal orientation of the housing and the approximately 90 degree internal angle orientation of the tray section 12 both utilize gravity to align and orient the stack 66 before it is secured for cutting. In one embodiment, a vibration mechanism is also used to orient the stack 66.

As mentioned, another embodiment of the invention contemplates the use of different sizes and configuration of cutting blades to enable the cutting of edges of varying dimensions and shapes. This is accomplished by switching the cutter body 28 of the cutter blade assembly 14 with other cutter bodies having cutter edges 30,32 with different radii of curvature, or even irregular, non-round edges 30,32. The curvature and dimension of the cutting edge 30,32 would effect the dimensions of the top groove 34, which in turn would require the use of spacer blocks 70,72 having bottom apexes 84 appropriately matched in dimension with the groove 34. To avoid confusion arising from the use of different size blade assemblies 16 and spacer blocks 70,72, the invention further comprises a method for matching the appropriate cutter blade assembly 14 with the proper size spacer blocks 70,72. As mentioned, one embodiment of such a matching system would comprise a color coded scheme, whereby a particular dimension of blade assembly 16 could be associated with a specific color. Also as mentioned, each spacer block 70,72 may be adapted to physical associate with the corresponding cutting body 28 when not in use.

Referring also to FIGS. 19 and 20, in an alternative embodiment, which may be substantially similar to the above-described embodiment in most or all other respects, the apparatus 110 includes a mounting plate 192 for mounting the apparatus 110 to a table or other stable support structure. The mounting plate 192 includes a central opening corresponding to the gap between the support panel members 118,120 and a corresponding opening in the table to allow cuttings to fall therethrough and into, for example, a waste container. A cushion component 194 is interposed between the mounting plate 192 and the table in order to prevent undesirable wear or other damage to the table which might otherwise be caused by direct contact with the mounting plate 192.

Adjustments to dimensions of the apparatus 10 are within the scope of the invention and would be known to those having skill in the art. For instance, the angle at which the support panel members 18,20 in the tray section 12 are disposed may be increased where the sheet material has an irregular shape or other than an approximately 90 degree orthogonal angle. Also, the width of the gap 22 may be modified to adjust the degree to which the corner of the stack 66 is exposed to the cutter blade assembly 14.

The many features and advantages of the invention are apparent from the detailed specification, and thus, is intended to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Having thus described the preferred embodiment of the invention, what is claimed as new and desired to be protected by Letters Patent includes the following:

1. An apparatus for cutting a corner of a stack of sheet material to have a non-square shape, the apparatus comprising:
a tray for receiving the stack of sheet material such that the corner of the stack of sheet material is located in a cutting path, with the tray being oriented substantially horizontally and including a first support panel and a second support panel angularly oriented relative to one another and separated by a gap through which the corner of the stack of sheet material projects into the cutting path; and
a blade assembly which is slidably movable along the cutting path to cut the corner of the stack of sheet material, with the blade assembly including a first cutting edge having the non-square shape and oriented toward a first direction along the cutting path and a second cutting edge having the non-square shape and oriented toward a second direction along the cutting path, wherein the first direction is opposite the second direction.

2. The apparatus as set forth in claim 1, wherein the stack of sheet material is a stack of paper cards.

3. The apparatus as set forth in claim 1, wherein the first support panel and the second support panel are oriented approximately 90 degrees relative to one another.

4. The apparatus as set forth in claim 1, wherein the cutting path is substantially linear, and the first direction corresponds to a forward direction and the second direction corresponds to a rearward direction along the substantially linear cutting path.

5. The apparatus as set forth in claim 1, further including a clamping assembly for exerting a clamping force on the stack of sheet material within the tray.

6. The apparatus as set forth in claim 1, further including one or more spacer blocks for occupying excess space within the tray which is not occupied by the stack of sheet material, wherein each spacer block fits closely within the bin and does not project into the cutting path.

7. An apparatus for cutting a corner of a stack of sheet material to have a non-square shape, the apparatus comprising:
a tray for receiving the stack of sheet material such that the corner of the stack of sheet material is located in a cutting path, with the tray including a bin having a gap through which the corner of the stack of sheet material projects into the cutting path;
a blade assembly which is slidably movable along the cutting path to cut the corner of the stack of sheet material, with the blade assembly including a first cutting edge having the non-square shape and oriented toward a first direction along the cutting path and a second cutting edge having the non-square shape and oriented toward a second direction along the cutting path; and
a drive assembly connected to the blade assembly for facilitating driving the blade assembly along the cutting path.

8. The apparatus as set forth in claim 7, wherein the stack of sheet material is a stack of paper cards.

9. The apparatus as set forth in claim 7, wherein the tray is oriented substantially horizontally.

10. The apparatus as set forth in claim 7, wherein the bin includes a first support panel and a second support panel angularly oriented relative to one another and separated by the gap.

11. The apparatus as set forth in claim 7, wherein the cutting path is substantially linear, and the first direction corresponds to a forward direction and the second direction corresponds to a rearward direction along the substantially linear cutting path.

12. The apparatus as set forth in claim 7, wherein a top surface of the blade assembly has a groove which corresponds to the non-square shape

13. The apparatus as set forth in claim 7, wherein the non-square shape is a substantially rounded shape, and wherein the first cutting edge and the second cutting edge each include a first blade end and a second blade end, and wherein the first blade end and the second blade end are flared.

14. The apparatus as set forth in claim 7, further including one or more spacer blocks for occupying space within the tray which is not occupied by the stack of sheet material, wherein each spacer block fits closely within the bin and does not project into the cutting path.

15. The apparatus as set forth in claim 14, wherein there are at least a first spacer block and a second spacer block for positioning in front of and behind the stack of sheet material, respectively.

16. The apparatus as set forth in claim 7, further including a clamping assembly for exerting a clamping force on the stack of sheet material within the bin.

17. The apparatus asset forth in claim 16, wherein the clamping assembly includes a threaded rod having a first rod end and a second rod end, and a handle connected to the first rod end for turning the threaded rod.

18. The apparatus as set forth in claim 16, further including a spacer block which is interposed between the clamping assembly and the stack of sheet material.

19. The apparatus as set forth in claim 18, wherein the spacer block includes an engagement surface against which the clamping assembly exerts the clamping force, and wherein the engagement surface is angled relative to a direction of the clamping force so as to force the spacer block both against the bin and against the stack of sheet material.

20. An apparatus for cutting a corner of a stack of sheet material to have a non-square shape, the apparatus comprising:
a tray for receiving the stack of sheet material such that the corner of the stack of sheet material is located in a linear cutting path, with the tray being oriented substantially horizontally and including a bin having a gap through which the corner of the stack of paper sheet material projects into the linear cutting path;
a blade assembly which is slidably movable along the linear cutting path to cut the corner of the stack of sheet material, with the blade assembly including a first cutting edge having the non-square shape and oriented toward a forward direction along the linear cutting path and a second cutting edge having the non-square shape and oriented toward a rearward direction along the linear cutting path;
a drive assembly connected to the blade assembly for driving the blade assembly along the cutting path, with the drive assembly including a handle to facilitate grasping and exerting a driving force against the blade assembly;
a clamping assembly for exerting a clamping force on the stack of sheet material within the bin; and
a spacer block which is interposed between the clamping assembly and the stack of sheet material, wherein the spacer block fits closely within the bin and does not project into the cutting path.
